(19) United States
(12) Patent Application Publication
(10) Pub. No.: US 2024/0169596 A1
(43) Pub. Date: May 23, 2024

(54) ENCODING METHOD, DECODING METHOD, AND DEVICE FOR POINT CLOUD COMPRESSION

(71) Applicant: Industrial Technology Research Institute, Hsinchu (TW)

(72) Inventors: Sheng-Po Wang, Taoyuan City (TW); Jie-Ru Lin, Yilan County (TW); Ching-Chieh Lin, Taipei City (TW); Chun-Lung Lin, Taipei City (TW)

(73) Assignee: Industrial Technology Research Institute, Hsinchu (TW)

(21) Appl. No.: 17/988,783

(22) Filed: Nov. 17, 2022

(51) Int. Cl. G06T 9/00; G06T 9/40; H04N 19/137; H04N 19/172

(52) U.S. Cl. CPC G06T 9/001; G06T 9/40; H04N 19/137; H04N 19/172

(57) ABSTRACT

An encoding method, a decoding method, and a device for point cloud compression are provided. The encoding method includes the following. Point cloud data corresponding to a first frame is obtained, and is distinguished into a global point cloud set and at least one object point cloud set according to a reference frame. The object point cloud set corresponds to at least one reference object point cloud set. A global dynamic model corresponding to the global point cloud set is calculated and an object dynamic model corresponding to the object point cloud set is calculated. A bitstream is generated. The bitstream includes the global point cloud set, the global dynamic model corresponding to the global point cloud set, a serial number of each object point in the reference object point cloud set, and the object dynamic model corresponding to the object point cloud set.

### BACKGROUND

### Technical Field

The disclosure relates to an encoding method, a decoding method, and a device for point cloud compression.

### Description of Related Art

Currently, three-dimensional (3D) point data commonly used to present complex geometric structures are referred to as a point cloud. The point cloud is composed of a plurality of points. Each point may be presented by a specific coordinate system (e.g., a Cartesian coordinate system), and texture data related to the point may be additionally recorded. Therefore, the amount of data in the point cloud is relatively great.

In addition, compression efficiency in compressing a dynamic image by geometric-structure-based point cloud compression (PCC) is adversely affected, which may result from that the PCC technology does not compress frames in the dynamic image through association between the frames.

### SUMMARY

An embodiment of the disclosure provides an encoding method for point cloud compression. The encoding method includes the following. Point cloud data corresponding to a first frame is obtained. The point cloud data is distinguished into a global point cloud set and at least one object point cloud set according to a reference frame. The at least one object point cloud set corresponds to at least one reference object point cloud set in the reference frame. A global dynamic model corresponding to the global point cloud set is calculated and at least one object dynamic model corresponding to the at least one object point cloud set is calculated. A bitstream is generated. The bitstream includes the global point cloud set, the global dynamic model corresponding to the global point cloud set, a serial number of each of the object point cloud set in the at least one reference object point cloud set, and the at least one object dynamic model corresponding to the at least one object point cloud set.

An embodiment of the disclosure provides a decoding method for point cloud compression. The decoding method includes the following. A bitstream is obtained. The bitstream includes reference point cloud data corresponding to a reference frame, a global point cloud set corresponding to a first frame, a global dynamic model corresponding to the global point cloud set, a serial number of at least one object point cloud set in at least one reference object point cloud set, and at least one object dynamic model corresponding to the at least one object point cloud set. The reference point cloud data includes the at least one reference object point cloud set. First point cloud data corresponding to the first frame is reconstructed according to the reference point cloud data, the global point cloud set corresponding to the first frame, the global dynamic model, the serial number of the at least one object point cloud set in the at least one reference object point cloud set, and the corresponding at least one object dynamic model.

An embodiment of the disclosure provides a device for point cloud compression. The device for point cloud compression includes a processor and a memory. The memory is coupled to the processor to temporarily store data. The processor obtains point cloud data corresponding to a first frame and distinguishes the point cloud data into a global point cloud set and at least one object point cloud set according to a reference frame. The at least one object point cloud set corresponds to at least one reference object point cloud set in the reference frame. The processor calculates a global dynamic model corresponding to the global point cloud set, calculates at least one object dynamic model corresponding to the at least one object point cloud set, and generates a bitstream. The bitstream includes the global point cloud set, the global dynamic model corresponding to the global point cloud set, a serial number of each of the object point cloud set in the at least one reference object point cloud set, and the at least one object dynamic model corresponding to the at least one object point cloud set.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of an image processing system for point cloud compression according to an embodiment of the disclosure.

FIG. 2 is a flowchart of an encoding method for point cloud compression according to an embodiment of the disclosure.

FIG. 3 is a schematic diagram of a plurality of frames having point cloud data according to an embodiment of the disclosure.

FIG. 4 is a detailed flowchart of step S220 of FIG. 2 according to an embodiment of the disclosure.

FIG. 5 is a schematic diagram of a global point cloud set and an object point cloud set according to an embodiment of the disclosure.

FIG. 6 is a detailed flowchart of step S240 of FIG. 2 according to an embodiment of the disclosure.

FIG. 7 is a schematic diagram of an object point cloud set and a sub-object point cloud set according to an embodiment of the disclosure.

FIG. 8 is a schematic diagram of a point cloud structure, an object point cloud set, and a sub-object point cloud set of a first frame being integrated by an octree structure according to an embodiment of the disclosure.

FIG. 9 is a detailed flowchart of searching a reference frame for a motion vector corresponding to each sub-set in point cloud data of a first frame according to an embodiment of the disclosure.

FIG. 10 is a schematic diagram of distinguishing a cluster corresponding to the first frame and a reference cluster corresponding to the reference frame in FIG. 9 with a hexahedral bounding box.

FIG. 11 is a schematic diagram of distinguishing a cluster corresponding to the first frame and a reference cluster corresponding to the reference frame in FIG. 9 with a two-dimensional block.

FIG. 12 is a flowchart of a decoding method for point cloud compression according to an embodiment of the disclosure.

### DESCRIPTION OF THE EMBODIMENTS

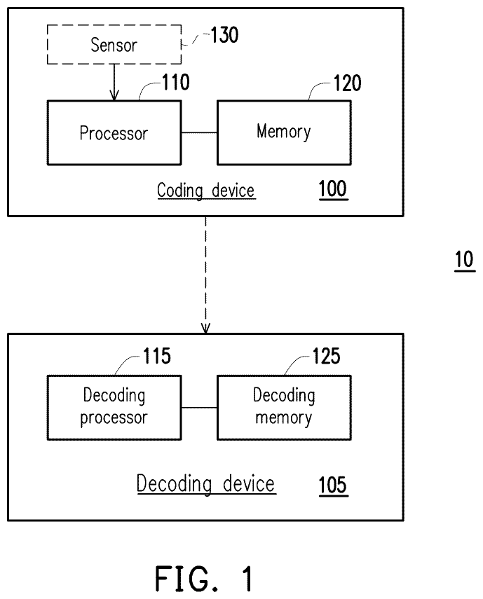

FIG. 1 is a block diagram of an image processing system 10 for point cloud compression according to an embodiment of the disclosure. The image processing system 10 may be configured to transmit an image having point cloud data. The image processing system 10 of this embodiment may be an application device of technology related to point cloud data, for example, corresponding devices and chips with an airborne light detection and ranging (LIDAR), 3D environment identification of automated navigation technology, equipped with point cloud encoding and decoding technology, or the like. The image processing system 10 for point cloud compression in FIG. 1 includes an encoding device 100 and a decoding device 105.

The encoding device 100 mainly includes a processor 110 and a memory 120, and may further include a sensor 130. The sensor 130 is configured to capture and measure the current environment or a frame to be encoded to generate corresponding point cloud data. The sensor 130 may be a 3D scanning instrument. The encoding device 100 in the image processing system 10 may be provided with the sensor 130 therein. Alternatively, the processor 110 of the encoding device 100 may obtain the point cloud data of the frame to be encoded through an external 3D scanning instrument. The processor 110 and the memory 120 cooperate with each other to realize steps of the embodiments of the disclosure, converting the point cloud data into a bitstream of a plurality of distinguished point cloud data and motion vectors corresponding to the point cloud data.

The decoding device 105 may receive the bitstream from the encoding device 100, and restore the complete point cloud data corresponding to each frame according to the distinguished point cloud data and dynamic models corresponding to the point cloud data (the dynamic model may include the motion vectors, for example) in the bitstream. Thus, the image having point cloud data in the bitstream can be smoothly decoded and played. The decoding device 105 of this embodiment includes a decoding processor 115 and a decoding memory 125. The decoding memory 125 is configured to temporarily store data required by the decoding processor 115.

Dynamic point cloud data may be distinguished into a global point cloud set including a static background (e.g., a building, a road, etc.) and object point cloud sets (e.g., persons, cars, etc.). In this embodiment, motion compensation is performed on the dynamic point cloud data and a motion model (e.g., the motion vector) is built to reduce the amount of data in the point cloud data. In other words, in this embodiment, the point cloud data is distinguished into a global point cloud set and object point cloud sets, and dynamic models (e.g., the motion vectors) for motion compensation are respectively calculated therefor to describe the point cloud data of the frame by utilizing the dynamic models and to encode and decode the point cloud data. In the embodiments of the disclosure, with inter-frame prediction technology, the point cloud data of some frames are presented as motion vectors, thus reducing the amount of data in the bitstream, facilitating transmission of the bitstream having point cloud data, and reducing the limitation of transmission bandwidth.

In addition, shifts of the global point cloud set between two frames mainly comes from movement of the viewing angle of the user or the sensor 130 of FIG. 1. Therefore, dynamic compensation may be performed through view angle rotation and translation. In other words, a global motion vector includes a global translation vector and a global rotation vector. Furthermore, motion compensation of the object point cloud sets comes from movement or motion of the object point cloud sets. Therefore, in addition to the global motion vector, an object motion vector for describing the moving object also includes an object translation vector and an object rotation vector. Moreover, the object point cloud sets (e.g., persons) may also have detailed structures (e.g., a torso, a thigh, a calf, etc.). The detailed structures (hereafter referred to as sub-local objects) also produce different motions. Therefore, to present the point cloud data of a first frame in more detail by utilizing point cloud data of a reference frame and the motion vectors, in this embodiment, the object point cloud sets may be distinguished in more detail, and motion vectors of the distinguished detailed structures may be calculated to describe the motions.

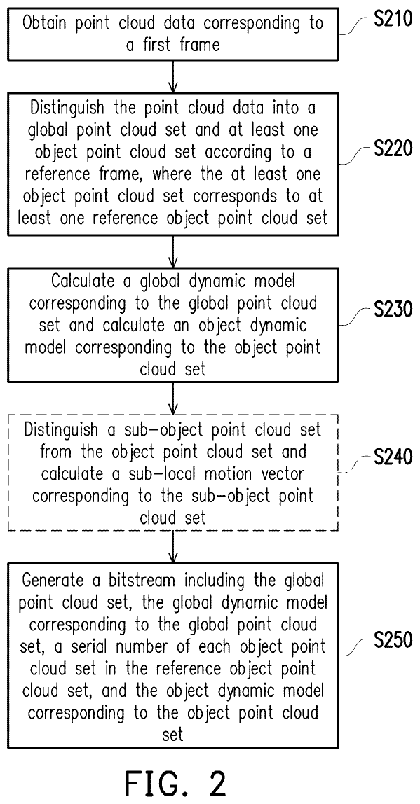

FIG. 2 is a flowchart of an encoding method for point cloud compression 200 according to an embodiment of the disclosure. The encoding method 200 of FIG. 2 may be applied to the encoding device 100 of the image processing system 10 of FIG. 1. In the encoding method 200 according to this embodiment, point cloud data corresponding to a first frame is first obtained (corresponding to step S210). The point cloud data is distinguished into a global point cloud set and at least one object point cloud set according to a reference frame. The object point cloud set corresponds to at least one reference object point cloud set in the reference frame (corresponding to step S220). A global dynamic model corresponding to the global point cloud set is calculated, and at least one object dynamic model corresponding to the at least one object point cloud set is calculated (corresponding to step S230), thus separating the object point cloud set from the global point cloud set.

In the encoding method 200, the object point cloud set may also be divided into more detailed sub-local objects (e.g., detailed structures) through an linear regression algorithm, and motion vectors may be respectively calculated according to the sub-local objects. In other words, sub-object point cloud sets in the object point cloud set may be distinguished in detail based on the object point cloud set, and sub-local motion vectors corresponding to the sub-object point cloud sets may be calculated (corresponding to step S240).

Lastly, in the encoding method 200, a bitstream is generated. The bitstream includes the global point cloud set, the global dynamic model corresponding to the global point cloud set, a serial number of each object point cloud set in the reference object point cloud set, and the object dynamic model corresponding to the object point cloud set (corresponding to step S250). Specifically, in this embodiment, the global point cloud set, the object point cloud set, the sub-object point cloud set (if step S240 is performed), and corresponding motion vectors are integrated through an octree structure to generate the bitstream. In this embodiment, before the integration of the octree structure, 3D motion estimation is first performed on the point cloud data to find the motion vector of each point, and the motion vector of each object is then recorded with a hierarchical structure through the encoding method according to the embodiments of the disclosure. The embodiments of the disclosure will be described in detail below through various drawings accompanied with the steps of FIG. 2.

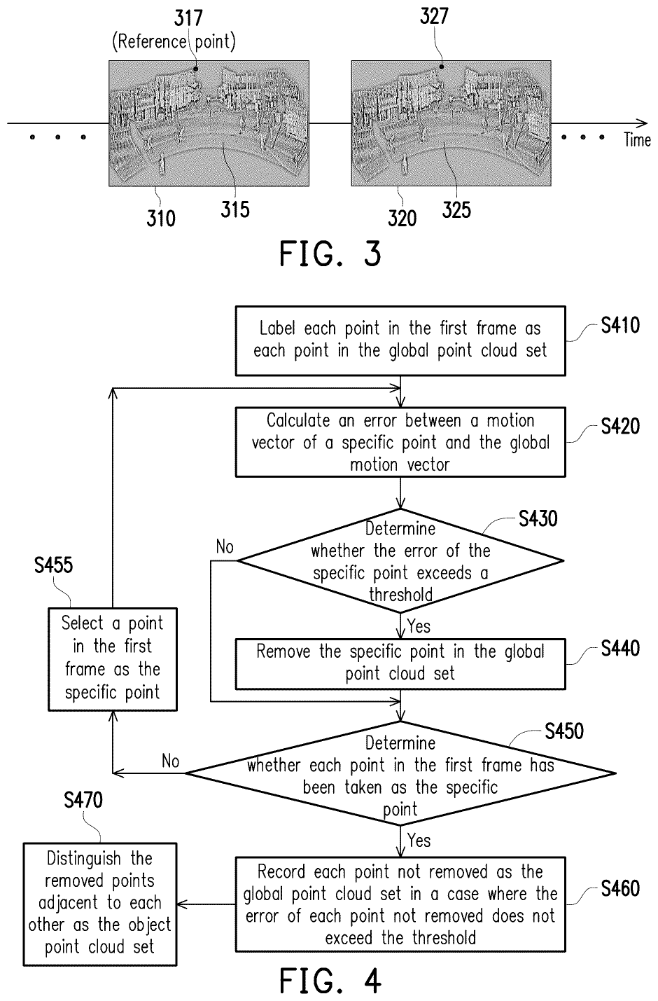

FIG. 3 is a schematic diagram of a plurality of frames having point cloud data according to an embodiment of the disclosure. In FIG. 3, a plurality of frames in an image are presented by the time axis, and two frames, i.e., a reference frame 310 and a first frame 320, are taken as an example. The frames of this embodiment present 3D backgrounds and 3D objects by utilizing point cloud data. Therefore, the reference frame 310 has corresponding point cloud data 315, and the first frame 320 has corresponding point cloud data 325. The bitstream generated by the encoding device 100 in FIG. 1 is an image format generated by encoding each of the frames as an example in FIG. 3.

With reference to FIG. 2 and FIG. 3 together, in step S210, the processor 110 of FIG. 1 obtains the point cloud data 325 corresponding to the first frame 320. The point cloud data 325 includes a plurality of points. In this embodiment, the point cloud data 315 and the point cloud data 325 each include a plurality of points. Each of the points includes at least a coordinate information thereof, and may further include texture information and the like. In this embodiment, the processor 110 of FIG. 1 may also obtain the reference frame 310 and the corresponding point cloud data 315 in advance, so that the reference frame 310 may be used subsequently. In other words, in this embodiment, the reference frame 310 is similar to the concept of the I frame in image compression technology, and the first frame 320 is similar to the concept of the P frame in image compression technology.

In step S220, the processor 110 of FIG. 1 distinguishes the point cloud data 325 in the first frame 320 into the global point cloud set and the at least one object point cloud set according to the reference frame 310. The object point cloud set corresponds to the reference object point cloud set in the reference frame 310. To reduce the amount of transmitted data, the object point cloud set corresponding to the first frame 320 is labeled with a serial number of the reference object point cloud set in the reference frame 310.

To be specific, in this embodiment, the global dynamic model corresponding to the global point cloud set may be calculated in the following steps. The processor 110 of FIG. 1 searches the point cloud data 315 of the reference frame 310 for a reference point (e.g., a reference point 317) corresponding to a sub-set (e.g., a sub-set 327) of the points in the point cloud data 325, and calculates a motion vector of the sub-set 327 in the point cloud data 325 relative to the reference point 317 in the point cloud data 315, accordingly knowing the motion vector corresponding to the sub-set 327. Then, motion vectors corresponding to the sub-sets are calculated based on the sub-sets of the points in the point cloud data 325 according to the steps above, and the motion vectors of the sub-sets are integrated to generate a frame motion vector set. In other words, the processor 110 of FIG. 1 searches for the closest point (the reference point 317) located in the point cloud data 315 of the reference frame 310 based on the sub-set 327 in the point cloud data 325 corresponding to the first frame 320, and calculates a translation vector and a rotation angle from the sub-set 327 to the reference point 317 to calculate the motion vector of the sub-set 327. Moreover, the processor 110 of FIG. 1 processes each sub-set in the point cloud data 325 as described above, so that each point has a motion vector. The processor 110 of FIG. 1 integrates the motion vectors of the sub-sets in the point cloud data 325. Moreover, the integrated motion vector is referred to as the frame motion vector set of the first frame 320 for convenience in subsequent description.

Based on the frame motion vector set, in step S220, the processor 110 of FIG. 1 distinguishes the point cloud data into the global point cloud set and the at least one object point cloud set according to the reference frame. To be specific, the processor 110 of FIG. 1 calculates an estimate global motion vector according to the frame motion vector set. For example, the estimate global motion vector is obtained by averaging all motion vectors in the frame motion vector set. The processor 110 of FIG. 1 compares each motion vector in the frame motion vector set with the estimate global motion vector to distinguish at least one object point cloud set from the point cloud data. For example, in response to the difference between a motion vector of a specific sub-set and the estimate global motion vector being within a threshold, it indicates a relatively high probability the specific sub-set belongs to the global point cloud set. Therefore, the specific sub-set is retained in the global point cloud set. Comparatively, the difference between a motion vector of a specific sub-set and the estimate global motion vector exceeding the threshold indicates a higher probability that the specific sub-set belongs to the object point cloud set instead of the global point cloud set. Therefore, a plurality of sub-sets belonging to the object point cloud set are removed in the point cloud data. After the comparison, the point cloud data from which the object point cloud set is removed may be taken as the global point cloud set. Moreover, the processor 110 of FIG. 1 individually distinguishes the removed points (sub-sets) that are adjacent to each other into the at least one object point cloud set.

In step S230, the processor 110 of FIG. 1 first calculates the global dynamic model corresponding to the global point cloud set. The global dynamic model includes the global motion vector. The processor 110 of FIG. 1 further recalculates the global motion vector corresponding to the global point cloud set, which includes the global motion vector, according to the frame motion vector set. In other words, the object point cloud set has been removed from the global point cloud set here. Therefore, the processor 110 of FIG. 1 obtains the corresponding motion vectors from the frame motion vector set for the sub-sets still existing in the global point cloud set, and averages the motion vectors to obtain a more accurate global motion vector.

According to this embodiment, the motion vector of the global point cloud set is formed of rotation and translation. Therefore, the global motion vector is formed based on the coordinate position of each point, a global rotation vector, and a global translation vector, and is expressed in this embodiment by linear transformation formula (1) below:

$$\\ \begin{matrix}MVg ( x , y , z ) \approx [ \begin{matrix}x \\ y \\ z\end{matrix} ] \cdot [ {M}_{G \_ rot} ] + [ {M}_{G \_ sh} ] & ( 1 )\end{matrix}$$

“(x, y, z)” represents the coordinate position of each point in the first frame 320 of FIG. 3, “MVg(x, y, z)” represents a global motion vector of the point cloud data 325, “M_{G_rot}” represents a global rotation vector of the point cloud data 325, and “M_{G_sh}” represents a global translation vector of the point cloud data 325. “M_{G_rot}” and “M_{G_sh}” are calculated by the following. A plurality of sampling points in the current frame (i.e., the first frame 320) are obtained. For each sampling point, in this embodiment, a point having the same coordinate as the sampling point in the reference frame 310 may serve as a center point, and a reference point corresponding to the sampling point is searched for using the center point and a predetermined range. Then, the global motion vector MVg(x, y, z) of each sampling point can be obtained by subtraction between the coordinates of the reference point and the corresponding sampling points. Next, “M_{G_rot}” and “M_{G_sh}” are calculated through linear regression.

After the global motion vector MVg(x, y, z), the global rotation vector M_{G_rot}, and the global translation vector M_{G_sh} are obtained, an error Total_Error_g of each point in the first frame 320 relative to the global motion vector can be calculated, as expressed in formula (2) below:

$$Totoal\_Error \_g = \sum {( MVg ( x , y , z ) - ( [ \begin{matrix}x \\ y \\ z\end{matrix} ] \cdot [ {M}_{G\_rot} ] + [ {M}_{G\_sh} ] ) )}^{2} \qquad ( 2 )$$

In step S230, the processor 110 of FIG. 1 calculates not only the global dynamic model corresponding to the global point cloud set, but also the object dynamic model corresponding to the object point cloud set. In this embodiment, each object point cloud set is compared with the reference object point cloud set corresponding to the object point cloud set and located on the reference frame to calculate an object motion vector of the object point cloud set. The object dynamic model includes the object motion vector. In this embodiment, the object motion vector may further be distinguished into a static object motion vector (with the object motion vector being the same as the global motion vector) and a dynamic object motion vector. Therefore, the object dynamic model is mainly based on the dynamic object motion vector.

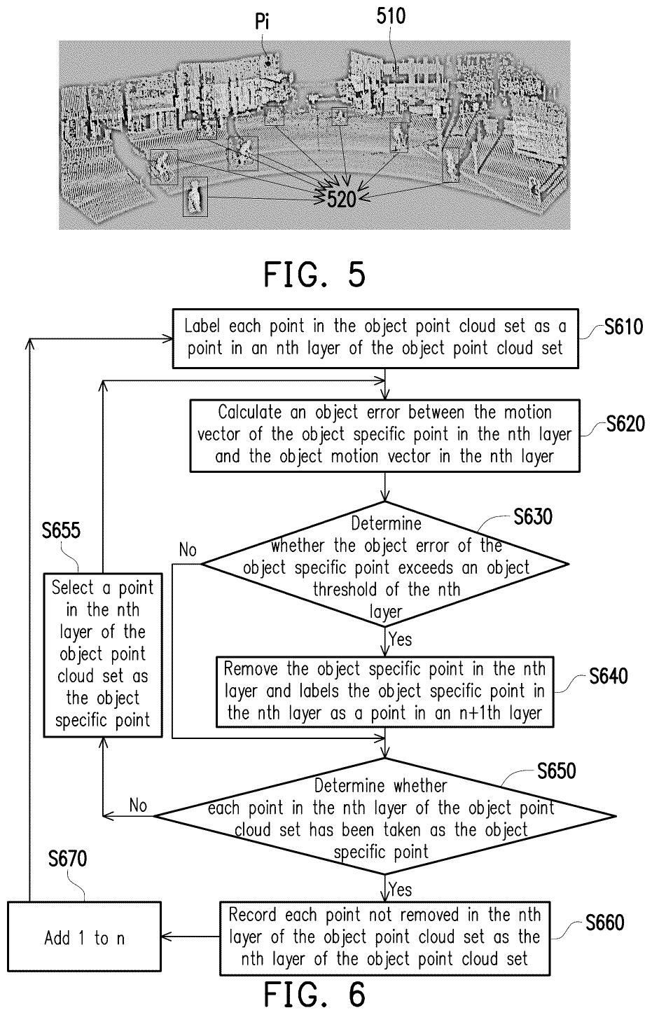

With reference to FIG. 4, FIG. 4 is a detailed flowchart of step S220 of FIG. 2 according to an embodiment of the disclosure. FIG. 5 is a schematic diagram of a global point cloud set and an object point cloud set according to an embodiment of the disclosure. A global point cloud set 510 in FIG. 5 is a global structure presented mainly by points of a static background, such as a building and a road. An object point cloud set 520 in FIG. 5 is a dynamic object, such as a pedestrian, a car, a bicycle, and the like, presented in the image with other motion vectors relative to the global structure (the global point cloud set 510).

With reference to FIG. 3, FIG. 4, and FIG. 5, in step S410, the processor 110 of FIG. 1 labels each point in the first frame 320 as each point in the global point cloud set. For convenience in description below, a “specific point Pi” is taken as an example of one of the points in the first frame 320. In other words, the specific point Pi is one of the points in the first frame 320. Moreover, the processor 110 of FIG. 1 obtains the global translation vector [M_{G_sh}] and the global rotation vector [M_{G_rot}] in the global point cloud set through an linear regression algorithm, thus calculating the global motion vector MVg(x, y, z) in the global point cloud set.

In step S420, the processor 110 of FIG. 1 calculates an error Errorᵢ between a motion vector MV(xᵢ, yᵢ, zᵢ) of the specific point Pi and the global motion vector MVg(x, y, z) , as expressed in formula (3) below:

$${Error}_{i} = MV ( {x}_{i} , {y}_{i} , {z}_{i} ) - ( [ \begin{matrix}x \\ y \\ z\end{matrix} ] \cdot [ {M}_{G\_rot} ] + [ {M}_{G\_sh} ] ) \qquad ( 3 )$$

In step S430, the processor 110 of FIG. 1 determines whether the error Errorᵢ of the specific point Pi exceeds a predetermined threshold. The error Errorᵢ exceeding the predetermined threshold indicates that the motion vector of the specific point Pi exceeds the global motion vector MVg(x, y, z). Therefore, the specific point Pi may be determined to belong to one of the points of the object point cloud set instead of one of the points of the global point cloud set. In addition, in response to the error Errorᵢ exceeding the predetermined threshold, the flow goes from step S430 to step S440, where the processor 110 of FIG. 1 removes the specific point Pi in the global point cloud set. The specific point Pi shown in FIG. 5 is located on a building and its error Errorᵢ does not exceed the predetermined threshold, so the specific point Pi belongs to one of the points in the global point cloud set 510.

In step S450, the processor 110 of FIG. 1 determines whether each point in the first frame 320 has been taken as the specific point Pi. If it is determined to be NO in step S450, the flow goes to step S455, where the processor 110 of FIG. 1 selects a point in the first frame 320 as the specific point Pi and proceeds with step S420 to step S450 to determine whether the error Errorᵢ of the specific point Pi exceeds the predetermined threshold. If it is determined to be YES in step S450, which indicates that the error of each point of the first frame 320 does not exceed the threshold, then the flow goes to step S460, where the processor 110 of FIG. 1 records each point that is not removed as the global point cloud set 510 of FIG. 5 in a case where the error of each point that is not removed does not exceed the threshold. In step S470, the processor 110 of FIG. 1 distinguishes the removed points that are adjacent to each other as the object point cloud set 520 of FIG. 5.

After obtaining the object point cloud set 520 of step S470, back to step S250 of FIG. 2, the processor 110 of FIG. 1 can calculate the object motion vector corresponding to each object point cloud set 520 according to the frame motion vector set (i.e., the integration of the motion set of the points of the first frame 320). An object motion vector MV_{obj}(x, y, z) may be divided into the global motion vector MVg(x, y, z), an object translation vector [M_{L_sh}], and an object rotation vector [M_{L_rot}], as expressed in formula (4) below:

$${MV}_{obj} ( x , y , z ) = MVg ( x , y , z ) + [ \begin{matrix}x \\ y \\ z\end{matrix} ] \cdot [ {M}_{L\_rot} ] + [ {M}_{L\_sh} ] \qquad ( 4 )$$

Therefore, the processor 110 of FIG. 1 subtracts the global motion vector MVg(x, y, z) from the object motion vector MV_{obj}(x, y, z), and then calculates the object translation vector [M_{L_sh}] and the object rotation vector [M_{L_rot}] according to the motion vector of each point of the object point cloud set 520 in a manner similar to that for the global motion vector MVg(x, y, z). Then, recursive operation is performed using an error Total_Error_L (as expressed in formula (5)) of the points of the object point cloud set 520 relative to the object motion vector MV_{obj}(x, y, z), to thus calculating the object translation vector [M_{L_sh}] and the object rotation vector [M_{L_rot}] that minimize the error Total_Error_L.

$$Total\_Error \_L = \sum {( {MV}_{obj} ( x , y , z ) - ( {MV}_{Global} ( x , y , z ) + [ \begin{matrix}x \\ y \\ z\end{matrix} ] \cdot [ {M}_{L\_rot} ] + [ {M}_{L\_sh} ] ) )}^{2} \qquad ( 5 )$$

The processor 110 of FIG. 1 calculates the global dynamic model corresponding to the global point cloud set, and calculates the object dynamic model corresponding to the object point cloud set (step S230 of FIG. 2). In addition, in step S240 of FIG. 2, the processor 110 of FIG. 1 may also distinguish a sub-object point cloud set from the object point cloud set and calculate a sub-local motion vector corresponding to the sub-object point cloud set. In other words, in this embodiment, the motion vector of each sub-set in the object point cloud set is compared with the object motion vector to distinguish at least one sub-object point cloud set from the object point cloud set, and the sub-local motion vector corresponding to the sub-object point cloud set is calculated. A plurality of points belonging to the sub-object point cloud set are removed in the object point cloud set. The object point cloud set from which the sub-object point cloud set is removed is taken as an updated object point cloud set. An updated object motion vector is calculated based on the updated object point cloud set.

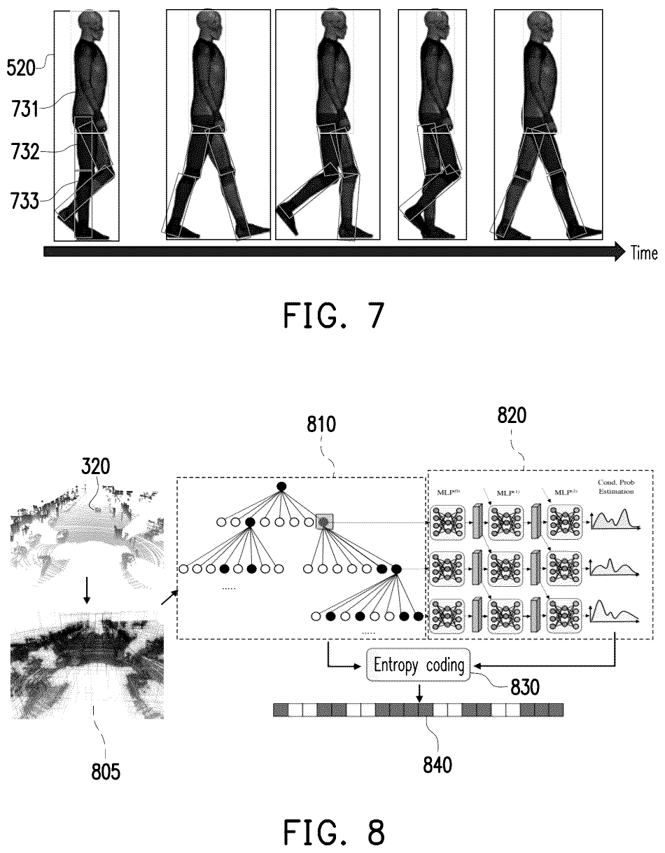

FIG. 6 is a detailed flowchart of step S240 of FIG. 2 according to an embodiment of the disclosure. FIG. 7 is a schematic diagram of an object point cloud set 520 and a sub-object point cloud set according to an embodiment of the disclosure. As can be seen from FIG. 7, in the object point cloud set 520 at different times, except for a sub-object point cloud set 731 of the torso part that has a similar motion vector, other sub-object point cloud sets (e.g., a left thigh labeled as a sub-object point cloud set 732 and a left calf labeled as a sub-object point cloud set 733) have relatively different motion vectors. Therefore, in this embodiment, after the object point cloud set 520 is distinguished, each sub-object point cloud set in the object point cloud set 520 may be hierarchically distinguished by utilizing the corresponding steps of FIG. 6.

With reference to FIG. 6 and FIG. 7, in step S610, the processor 110 of FIG. 1 labels each point in the object point cloud set as a point in an n^{th} layer of the object point cloud set, where n is a positive integer starting from 1. In other words, the processor 110 of FIG. 1 labels each point in the object point cloud set 520 as the 1^{st} layer of the object point cloud set. Furthermore, the processor 110 of FIG. 1 obtains a sub-object translation vector [M_{L1_sh}] and a sub-object rotation vector [M_{L1_rot}] in the 1^{st} layer of the object point cloud set through an linear regression algorithm, thus calculating a sub-object motion vector MV_{obj}_L1(x, y, z) of each point Pi in the 1^{st} layer.

In step S620, the processor 110 of FIG. 1 calculates an object error Errorᵢₙ between the motion vector MV(xᵢ, yᵢ, zᵢ) of the object specific point Pi in the n^{th} layer and the object motion vector MV_{obj}_L1(x, y, z) in the n^{th} (currently n=1) layer, as expressed in formula (6) below:

$${Error}_{in} = MV ( {x}_{i} , {y}_{i} , {z}_{i} ) - ( MVg ( x , y , z ) + [ \begin{matrix}x \\ y \\ z\end{matrix} ] \cdot [ {M}_{L 1 \_rot} ] + [ {M}_{L 1 \_sh} ] ) \qquad ( 6 )$$

In step S630, the processor 110 of FIG. 1 determines whether the object error Errorᵢₙ of the object specific point Pi exceeds an object threshold of the n^{th} (currently n=1) layer. The object error Errorᵢₙ exceeding the object threshold of the n^{th} (currently n=1) layer indicates that the motion vector of the object specific point Pi exceeds the object motion vector MV_{obj}_L1(x, y, z) in the n^{th} (currently n=1) layer. Therefore, the object specific point Pi may be determined to belong to one of the points of the object point cloud set in an n+1th layer instead of one of the points of the object point cloud set in the nth layer. In addition, in response to the error Errorᵢₙ exceeding the predetermined threshold, the flow goes from step S630 to step S640, where the processor 110 of FIG. 1 removes the object specific point Pi in the n^{th} layer and labels the object specific point in the n^{th} layer as a point in the n+1^{th} layer to indicate that the object specific point Pi belongs to one of the points of the object point cloud set in the n+1^{th} layer instead of one of the points of the object point cloud set in the n^{th} (currently n=1) layer.

In step S650, the processor 110 of FIG. 1 determines whether each point in the n^{th} (currently n=1) layer of the object point cloud set 520 has been taken as the object specific point Pi. If it is determined to be NO in step S650, the flow goes to step S655, where the processor 110 of FIG. 1 selects a point in the n^{th} layer of the object point cloud set 520 as the object specific point Pi and proceeds with step S620 to step S650 to determine whether the error Errorᵢₙ of the object specific point Pi exceeds the object threshold of the n^{th} (currently n=1) layer. If it is determined to be YES in step S650, which indicates that the error of each point of the object point cloud set 520 in the n^{th} (currently n=1) layer does not exceed the object threshold, then the flow goes to step S660, where the processor 110 of FIG. 1 records each point that is not removed in the n^{th} (currently n=1) layer of the object point cloud set 520 as the n^{th} (currently n=1) layer of the object point cloud set 520 in a case where the object error of each point that is not removed in the n^{th} (currently n=1) layer does not exceed the threshold of the object in the n^{th} layer. Then, in step S670, the processor 110 of FIG. 1 adds 1 to n to repeat the steps above, thus hierarchically obtaining the object point cloud set 520 and the sub-object point cloud sets thereof.

Back to step S250 of FIG. 2, the processor 110 of FIG. 1 generates the bitstream. The bitstream includes a global point cloud set (e.g., the global point cloud set 510 of FIG. 5), a global dynamic model (e.g., the global motion vector) corresponding to the global point cloud set, a serial number of each object point cloud set (e.g., the object point cloud set 520 of FIG. 5) in the reference object point cloud set, and an object dynamic model (e.g., the object motion vector) corresponding to the object point cloud set. Here, the flow of step S250 of FIG. 2 is described in detail with FIG. 8.

FIG. 8 is a schematic diagram of a point cloud structure, an object point cloud set, and a sub-object point cloud set of a first frame being integrated by an octree structure according to an embodiment of the disclosure. The upper left part of FIG. 8 shows the point cloud structure 325 of the first frame 320. The lower left part of FIG. 8 shows an octree construction diagram 805 distinguishing the point cloud structure on the basis that the global point cloud set and the object point cloud set are distinguished. The middle part of FIG. 8 shows an octree structure 810 transformed from the octree construction diagram 805. The octree structure 810 distinguishes the global point cloud set, the object point cloud set, and the motion vectors corresponding to the point cloud sets. The upper right part of FIG. 8 shows an entropy model 820 in a tree-shaped structure corresponding to one point in the octree structure 810. Therefore, in step S250 of FIG. 2, the processor 110 of FIG. 1 establishes the octree structure 810 of the point cloud data 325 according to the global point cloud set 510 and the object point cloud set 520. In addition, through entropy coding 830 of FIG. 8, the processor 110 of FIG. 1 encodes the point sets (e.g., the global point cloud set, the object point cloud set, sub-object point cloud set in the n^{th} layer, etc.) and the motion vectors corresponding to the point cloud sets that are distinguished according to the octree structure 810 to generate a bitstream 840.

In step S220 of FIG. 2, it is possible to search for the reference point 317 corresponding to the sub-set 327 in the point cloud data 325 in the first frame 320 in the reference frame 310 in various manners as consumption of a great amount of calculation may be required to search for a motion vector within a great range search in a 3D space. This embodiment provides several manners to first determine a preliminary search range during search for a reference point, and then search for the reference point from the search range, reducing the amount of calculation. Those who apply this embodiment may realize the functions above in other manners depending on their needs.

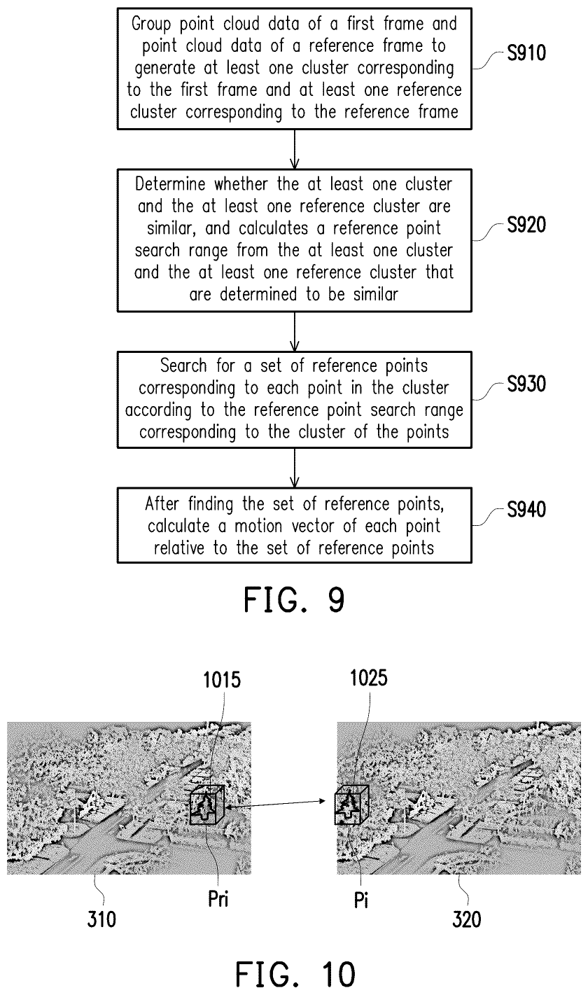

FIG. 9 is a detailed flowchart of searching a reference frame for a motion vector corresponding to each sub-set in point cloud data of a first frame according to an embodiment of the disclosure. FIG. 10 is a schematic diagram of distinguishing a cluster 1025 corresponding to the first frame 320 and a reference cluster 1015 corresponding to the reference frame 310 in FIG. 9 with a hexahedral bounding box. With reference to FIG. 3 and FIG. 9 together, in step S910, the processor 110 of FIG. 1 groups the point cloud data of the first frame 320 and the point cloud data of the reference frame 310 to generate at least one cluster corresponding to the first frame 320 and at least one reference cluster corresponding to the reference frame.

In step S920, the processor 110 of FIG. 1 determines whether the at least one cluster and the at least one reference cluster are similar, and calculates a reference point search range from the at least one cluster and the at least one reference cluster that are determined to be similar. For example, in FIG. 10, a tree separated by the bounding box is taken as an example for the cluster 1025 corresponding to the first frame 320 and the reference cluster 1015 corresponding to the reference frame 310. The processor 110 of FIG. 1 finds corresponding clusters for position information of each cluster in the reference frame 310 and the first frame 320 and point number information of each corner in the hexahedral bounding box. For convenience in description, it is assumed here that the cluster 1025 and the reference cluster 1015 are similar in their position information and the point number information of each corner (or described as that the cluster 1025 and the reference cluster 1015 match each other).

In step S930, the processor 110 of FIG. 1 searches for a set of reference points (e.g., a set of reference points Pri) corresponding to each point Pi in the first frame 320 according to the reference point search range (e.g., the reference cluster 1015) corresponding to the cluster (e.g., the cluster 1025) where the point Pi is located. In this embodiment, a motion vector model between the cluster 1025 and the reference cluster 1015 may be calculated according to the motion vectors between endpoints (e.g., eight corners) of the bounding boxes of the cluster 1025 and the reference cluster 1015 that are similar. As shown in FIG. 10, the point Pi is located at the lower left corner of the cluster 1025. Therefore, the motion vector model may set the reference point search range at the lower left corner of the reference cluster 1015. In addition, a predicted reference point (e.g., the endpoint located near the reference point Pri) corresponding to each point in the similar cluster 1025 is calculated according to the motion vector model, and the reference point search range is obtained according to the predicted reference point. In step S940, after finding the set of reference points Pri, the processor 110 of FIG. 1 calculates the motion vector of each point Pi relative to the set of reference points Pri.

In FIG. 9 and FIG. 10, the clusters are distinguished with the bounding box. Those who apply this embodiment may also distinguish the clusters with a two-dimensional block or in other manners, and other manners may also be adopted for the reference point search range. FIG. 11 is a schematic diagram of distinguishing the cluster 1025 corresponding to the first frame 320 and the reference cluster 1015 corresponding to the reference frame 310 in FIG. 9 with a two-dimensional block.

With reference to FIG. 9 and FIG. 11 together, in step S910, the processor 110 of FIG. 1 groups the point cloud data of the first frame 320 and the point cloud data of the reference frame 310 to generate the at least one cluster 1025 corresponding to the first frame 320 and the at least one reference cluster 1015 corresponding to the reference frame. In step S920, the processor 110 of FIG. 1 determines whether the cluster 1025 and the reference cluster 1015 are similar, and calculates the reference point search range from the cluster 1025 and the reference cluster 1015 that are determined to be similar. To be specific, the processor 110 of FIG. 1 captures a topmost point Tcurr and a bottommost point Bcurr of the cluster 1025 (e.g., a tree shown in the first frame 320 in part (A) of FIG. 11), and compares the points with a topmost point Tref and a bottommost point Bref of the reference cluster 1015 (e.g., a tree shown in the reference frame 310 in part (A) of FIG. 11), thus determining whether the cluster 1025 and the reference cluster 1015 are similar. For convenience in description, it is assumed here that the cluster 1025 and the reference cluster 1015 are similar in point number information of their topmost points Tcurr and Tref and the bottommost points Bcurr and Bref.

With reference to part (B) of FIG. 11, the processor 110 of FIG. 1 calculates a center of gravity and endpoints of each of the cluster 1025 and the reference cluster 1015, calculates a search range parameter (corresponding parameters of an elliptical search range 1155 as shown in part (B) of FIG. 11) by utilizing the center of gravity and the endpoints, and defines the reference point search range according to the search range parameter (e.g., the length of the long axis and the length of the short axis of the elliptical search range, etc.) and a center point PA of the reference cluster.

In step S930, the processor 110 of FIG. 1 searches for a set of reference points (e.g., the set of reference points Pri) corresponding to each point Pi in the first frame 320 according to the reference point search range (e.g., the elliptical search range 1155) corresponding to the cluster (e.g., the cluster 1025) where the point Pi is located. In step S940, after finding the set of reference points Pri, the processor 110 of FIG. 1 calculates the motion vector of each point Pi relative to the set of reference points Pri.

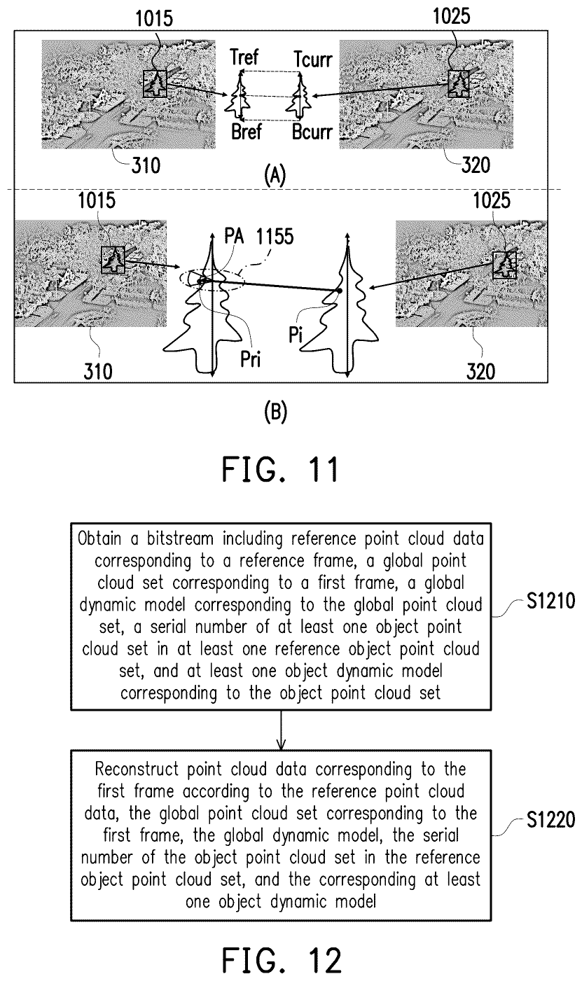

FIG. 12 is a flowchart of a decoding method for point cloud compression 1200 according to an embodiment of the disclosure. The decoding method 1200 may be applied to the decoding device 105 of FIG. 1. In step S1210, the decoding processor 115 of the decoding device 105 obtains a bitstream. The bitstream includes reference point cloud data corresponding to a reference frame, a global point cloud set corresponding to a first frame, a global dynamic model corresponding to the global point cloud set, a serial number of at least one object point cloud set in at least one reference object point cloud set, and at least one object dynamic model corresponding to the object point cloud set. The reference point cloud data includes the at least one reference object point cloud set.

In step S1220, the decoding processor 115 of the decoding device 105 reconstructs point cloud data corresponding to the first frame according to the reference point cloud data, the global point cloud set corresponding to the first frame, the global dynamic model, the serial number of the object point cloud set in the reference object point cloud set, and the corresponding at least one object dynamic model. Accordingly, the decoding device 105 can restore the point cloud data in the first frame and proceeds with playing the bitstream or corresponding applications.

To be specific, a global motion vector in the global dynamic model mainly includes a global translation vector and a global rotation vector, and an object motion vector in the object dynamic model include an object translation vector and an object rotation vector. Therefore, the steps of reconstructing first point cloud data corresponding to the first frame include the following. A plurality of global points are obtained from the reference point cloud data according to the global point cloud set. A global point product is produced after each global point is multiplied by the global rotation vector. The global translation vector is added to the global point product to form global point cloud information. Moreover, for each object point cloud set corresponding to the first frame, a plurality of object points are obtained from the reference point cloud data according to the serial number in the at least one reference object point cloud set. An object point product is produced after each object point is multiplied by the object rotation vector. The object translation vector is added to the object point product to form at least one object point cloud information. Lastly, the global point cloud information and the at least one object point cloud information are combined into the point cloud data.

In summary of the foregoing, in the encoding method, the decoding method, and the device for point cloud compression according to the embodiments of the disclosure, the point cloud data is distinguished into the global point cloud set, the object point cloud set (which may further include sub-local objects), and the corresponding motion vectors. Therefore, the point cloud data corresponding to the current frame is presented based on the point cloud data in the reference frame to thus compress the point cloud data with inter-frame prediction technology. Moreover, in the embodiments of the disclosure, the distinguished point cloud objects (i.e., the global point cloud set, the object point cloud set, the sub-local objects, and the corresponding motion vectors) are integrated by utilizing an octree structure, thus reducing the amount of data in the point cloud data in the bitstream by utilizing high-efficiency encoding technology and improving the performance of point cloud compression.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An encoding method for point cloud compression, comprising:
obtaining point cloud data corresponding to a first frame;
distinguishing the point cloud data into a global point cloud set and at least one object point cloud set according to a reference frame, wherein the at least one object point cloud set corresponds to at least one reference object point cloud set in the reference frame;
calculating a global dynamic model corresponding to the global point cloud set and calculating at least one object dynamic model corresponding to the at least one object point cloud set; and
generating a bitstream, wherein the bitstream comprises the global point cloud set, the global dynamic model corresponding to the global point cloud set, a serial number of each of the object point cloud set in the at least one reference object point cloud set, and the at least one object dynamic model corresponding to the at least one object point cloud set.

2. The encoding method according to claim 1, wherein calculating the global dynamic model corresponding to the global point cloud set comprises:
searching the reference frame for a set of reference points corresponding to a sub-set of a plurality of points in the point cloud data, calculating a motion vector of the sub-set relative to the set of reference points, and integrating the motion vector of the sub-set to generate a frame motion vector set;
calculating an estimate global motion vector according to the frame motion vector set;
comparing each motion vector in the frame motion vector set with the estimate global motion vector to distinguish the at least one object point cloud set from the point cloud data;
removing a plurality of points belonging to the at least one object point cloud set in the point cloud data and taking the point cloud data from which the at least one object point cloud set is removed as the global point cloud set; and
calculating a global motion vector corresponding to the global point cloud set according to the frame motion vector set, wherein the global dynamic model comprises the global motion vector.

3. The encoding method according to claim 2, wherein calculating the at least one object dynamic model corresponding to the at least one object point cloud set comprises:
comparing each of the object point cloud set with the at least one reference object point cloud set corresponding to the object point cloud set to calculate an object motion vector of the at least one object point cloud set,
wherein the at least one object dynamic model comprises a dynamic object motion vector in the object motion vector.

4. The encoding method according to claim 3, further comprising:
comparing the motion vector of each of the sub-set in the at least one object point cloud set with the object motion vector to distinguish at least one sub-object point cloud set from the at least one object point cloud set and calculating a sub-local motion vector corresponding to the sub-object point cloud set; and
removing a plurality of points belonging to the at least one sub-object point cloud set in the at least one object point cloud set, taking the at least one object point cloud set from which the at least one sub-object point cloud set is removed as at least one updated object point cloud set, and calculating an updated object motion vector according to the at least one updated object point cloud set,
wherein the bitstream further comprises a sub-serial number of the sub-object point cloud set in the at least one reference object point cloud set and the sub-local motion vector corresponding to the sub-object point cloud set.

5. The encoding method according to claim 1, wherein generating the bitstream comprises:
establishing an octree structure of the point cloud data according to the global point cloud set and the at least one object point cloud set; and
encoding the global point cloud set, the global dynamic model, the serial number of the object point cloud set in the at least one reference object point cloud set, and the at least one object dynamic model corresponding to the at least one object point cloud set according to the octree structure to generate the bitstream.

6. The encoding method according to claim 1, wherein a global motion vector in the global dynamic model comprises a global translation vector and a global rotation vector, and an object motion vector in the object dynamic model comprises an object translation vector and an object rotation vector.

7. The encoding method according to claim 2, wherein searching the reference frame for the set of reference points corresponding to the plurality of points in the point cloud data comprises:
grouping the respective point cloud data of the first frame and the reference frame to generate at least one cluster corresponding to the first frame and at least one reference cluster corresponding to the reference frame;
determining whether the at least one cluster is similar to the at least one reference cluster and calculating a reference point search range from the at least one cluster and the at least one reference cluster being determined to be similar;
searching for the set of reference points corresponding to each of points in the cluster according to the reference point search range corresponding to each of the points in the cluster; and
calculating the motion vector of each of the points relative to the set of reference points after the set of reference points is obtained from searching.

8. The encoding method according to claim 7, wherein the at least one cluster and the at least one reference cluster are distinguished with a bounding box, and
calculating the reference point search range from the at least one cluster and the at least one reference cluster being determined to be similar comprises:
calculating a motion vector model according to the motion vectors between endpoints of the bounding boxes of the at least one cluster and the at least one reference cluster being determined to be similar; and
calculating a predicted reference point corresponding to each of the points in the at least one cluster being determined to be similar according to the motion vector model and obtaining the reference point search range according to the predicted reference point.

9. The encoding method according to claim 7, wherein the at least one cluster and the at least one reference cluster are distinguished with a two-dimensional block, and
calculating the reference point search range from the at least one cluster and the at least one reference cluster being determined to be similar comprises:
calculating a motion vector model according to the motion vectors between endpoints of the bounding boxes of the at least one cluster and the at least one reference cluster being determined to be similar; and
calculating a predicted reference point corresponding to each of the points in the at least one cluster being determined to be similar according to the motion vector model and obtaining the reference point search range according to the predicted reference point.

10. The encoding method according to claim 2, wherein removing the plurality of points belonging to the at least one object point cloud set in the point cloud data and taking the point cloud data from which the at least one object point cloud set is removed as the global point cloud set comprises:
labeling each of points in the first frame as each of points in the global point cloud set;
calculating an error between the motion vector of a specific point and the global motion vector, wherein the specific point is one of the points in the first frame;
determining whether the error of the specific point exceeds a threshold;
removing the specific point in the global point cloud set in response to the error exceeding the threshold; and
recording each of points not being removed as the global point cloud set in a case where the error of each of the points not being removed does not exceed the threshold.

11. The encoding method according to claim 10, wherein comparing each motion vector in the frame motion vector set with the estimate global motion vector to distinguish the at least one object point cloud set from the point cloud data comprises:
distinguishing removed points that are adjacent to each other into the at least one object point cloud set.

12. A decoding method for point cloud compression, comprising:
obtaining a bitstream, wherein the bitstream comprises reference point cloud data corresponding to a reference frame, a global point cloud set corresponding to a first frame, a global dynamic model corresponding to the global point cloud set, a serial number of at least one object point cloud set in at least one reference object point cloud set, and at least one object dynamic model corresponding to the at least one object point cloud set, wherein the reference point cloud data comprises the at least one reference object point cloud set; and
reconstructing first point cloud data corresponding to the first frame according to the reference point cloud data, the global point cloud set corresponding to the first frame, the global dynamic model, the serial number of the at least one object point cloud set in the at least one reference object point cloud set, and the corresponding at least one object dynamic model.

13. The decoding method according to claim 12, wherein a global motion vector in the global dynamic model comprises a global translation vector and a global rotation vector, and
reconstructing the first point cloud data corresponding to the first frame comprises:
obtaining a plurality of global points from the reference point cloud data according to the global point cloud set, producing a global point product after multiplying each of the global points by the global rotation vector, and adding the global translation vector to the global point product to form global point cloud information.

14. The decoding method according to claim 13, wherein an object motion vector in the object dynamic model comprises an object translation vector and an object rotation vector, and
reconstructing the first point cloud data corresponding to the first frame further comprises:
for each of the object point cloud set corresponding to the first frame, obtaining a plurality of object points from the reference point cloud data according to the serial number in the at least one reference object point cloud set, producing an object point product after multiplying each of the object points by the object rotation vector, and adding the object translation vector to the object point product to form at least one object point cloud information; and
combining the global point cloud information and the at least one object point cloud information into the first point cloud data.

15. A device for point cloud compression, comprising:
a processor; and
a memory coupled to the processor to temporarily store data,
wherein the processor obtains point cloud data corresponding to a first frame and distinguishes the point cloud data into a global point cloud set and at least one object point cloud set according to a reference frame, wherein the at least one object point cloud set corresponds to at least one reference object point cloud set in the reference frame, and
the processor calculates a global dynamic model corresponding to the global point cloud set, calculates at least one object dynamic model corresponding to the at least one object point cloud set, and generates a bitstream, wherein the bitstream comprises the global point cloud set, the global dynamic model corresponding to the global point cloud set, a serial number of each of the object point cloud set in the at least one reference object point cloud set, and the at least one object dynamic model corresponding to the at least one object point cloud set.
